(19) United States
(12) Patent Application Publication
(10) Pub. No.: US 2019/0153251 A1
(43) Pub. Date: May 23, 2019

(54) INK COMPOSITIONS

(71) Applicant: Hewlett-Packard Development Company, L.P., Fort Collins, CO (US)

(72) Inventors: Jayprakash C. BHATT, Corvallis, OR (US); Milton Neill JACKSON, Corvallis, OR (US); Larrie DEARDURFF, Corvallis, OR (US)

(73) Assignee: Hewlett-Packard Development Company, L.P., Fort Collins, CO (US)

(21) Appl. No.: 16/308,601

(22) PCT Filed: Oct. 6, 2016
(86) PCT No.: PCT/US2016/055707

§ 371 Date: Dec. 10, 2018

(51) Int. Cl. C09D 11/322; C09D 11/38; G01N 29/02

(52) U.S. Cl. CPC C09D 11/322; C09D 11/38; G01N 2291/02809; G01N 2291/02416; G01N 29/02

(57) ABSTRACT

The present disclosure is drawn to ink compositions including an aqueous liquid vehicle, from 3 wt % to 9 wt % pigment dispersed in the aqueous liquid vehicle by a polymer dispersant associated with pigment, and from 0.25 wt % to 1.2 wt % monovalent salt. The pigment to monovalent salt weight ratio in the ink composition can be from 5:1 to 25:1.

### BACKGROUND

Color pigments are typically dispersed or suspended in a liquid vehicle to be utilized in inks. A variety of colored pigments are difficult to disperse and stabilize in water-based vehicles due to the nature of the surface of pigments and the self-assembling behavior of pigments. One way to facilitate color pigment dispersion and sustained suspension in a liquid vehicle is to adding a dispersant, such as a polymer, to the liquid vehicle. The polymer stabilizes the dispersion and/or suspension of the pigments. Often, aqueous pigments based inks that are stabilized using polymer can penetrate print media resulting in low color saturation. Thus, enhancing color saturation of polymer dispersed pigments would be a desirable property to achieve generally.

### BRIEF DESCRIPTION OF THE DRAWINGS

Additional features and advantages of the disclosure will be apparent from the detailed description which follows, taken in conjunction with the accompanying drawings, which together illustrate, by way of example, features of the present technology. It should be understood that the figures are representative examples of the present technology and should not be considered as limiting the scope of the technology.

FIG. 1 depicts a graph of pigment colloidal vibrational current compared to ionic strength provided by a monovalent salt in cyan, magenta, and yellow ink in accordance with examples of the present disclosure;

FIG. 2 depicts a graph of absorbance compared to ionic strength provided by a monovalent salt in cyan, magenta, and yellow ink in accordance with examples of the present disclosure;

FIG. 3 depicts a graph of primary color saturation compared to increasing monovalent salt concentration in accordance with examples of the present disclosure; and

FIG. 4 depicts a graph of secondary color saturation compared to increasing monovalent salt concentration in accordance with examples of the present disclosure.

### DETAILED DESCRIPTION

The present disclosure is drawn to ink compositions, methods of making ink compositions, and methods of determining a crash point of a pigment dispersed by a polymer dispersant. In accordance with the present disclosure, a polymeric dispersant can be used to disperse or suspend color pigments that would otherwise clump together and settle out of the liquid vehicle. Polymers disperse the pigment by being absorbed, adsorbed, or otherwise attracted to the surface of the pigment particles. Two principal mechanisms of stabilization are steric stabilization and electrostatic stabilization. Steric stabilization occurs when the outer surface of a colored pigment becomes completely surrounded by polymer, thereby preventing individual pigments from clumping together. Electrostatic stabilization occurs when the outer surface of the pigments becomes essentially equally charged (or charged at least enough to remain suspended) in the suspension fluid. The equal charge on the outer surface of individual colored pigments results in a Coulomb-repulsion that prevents individual colored pigments from clumping together. The ink compositions and methods described herein provide for control of electrostatic stabilization of ink compositions by manipulating a concentration of an added monovalent salt, thereby allowing for the enhancement or increase of color saturation of the ink compositions when printed on plain, non-ColorLok® (HP, Inc.), print media. In accordance with this, the addition of a monovalent salt to a polymer dispersed pigmented ink can attenuate electrostatic stabilization. Thus, by controlling the concentration of monovalent salt, e.g., adding just enough to keep the dispersed pigment electrostatically stable without adding too much causing the pigment to crash, high color saturation, even on non-ColorLok® office media or plain paper, can be achieved.

Pigment crashing can occur when the stabilization forces, e.g., steric and electrostatic stabilization, do not provide enough stabilization to keep the pigments separated in space enough to prevent pigment crashing. This can cause the pigment to crash in on itself because there is not enough separation between particles. Thus, in the context of the present disclosure, “crash point” can be defined where a molar concentration (ionic strength) of a monovalent salt is just high enough that electrostatic stabilization provided by the polymer dispersant is unable to prevent the pigment from crashing. In other words, the crash point represents the molar concentration of the monovalent salt demarking the line between pigment stability and the pigment beginning to crash. In one example, the crash point of a pigment in an ink can be determined experimentally as described herein, e.g., trial and error or pigment colloidal vibrational current (CVI) techniques.

In accordance with this, by adding a monovalent salt at a concentration in an ink that brings the ionic strength (measured as the molar concentration of the added salt) just below the crash point, when the ink is printed on plain paper or non-ColorLok® paper, liquid vehicle absorbs into the fibrous paper substrate, thus increasing the molar concentration or ionic strength of the monovalent salt at the surface of the media. Because the ionic strength of the monovalent salt was very close to the crash point for the pigment in the ink reservoir (prior to printing), once just a small portion of the liquid vehicle rapidly absorbs into the plain paper media, the pigment crashes at the surface of the paper. Thus, much of the pigment remains at the surface when it crashes, and the color saturation can be increased compared to inks that are otherwise identical, but which have less (or no) monovalent salt therein.

In one example, the present disclosure is drawn to an ink composition including an aqueous liquid vehicle, from 3 wt % to 9 wt % pigment dispersed in the aqueous liquid vehicle by a polymer dispersant associated with pigment, and from 0.25 wt % to 1.2 wt % monovalent salt. In this example, the pigment to monovalent salt weight ratio in the ink composition can be from 5:1 to 25:1. In certain examples, the ratio can be from 9:1 to 20:1, or from 10:1 to 17:1.

In further detail, the monovalent salt can be added to the ink based on an identified crash point of the pigment in the ink. In these examples, the monovalent salt can also be present at a molar concentration from 30% to 95% of the crash point. In other examples, the monovalent salt can be present at a molar concentration from 50% to 90% of the crash point, or from 60% to 85% of the crash point. To illustrate one specific example, formulations can be prepared where the pigment remains stable while in an inkjet fluid container. However, when the ink composition is printed on non-ColorLok® paper such as plain paper, after just a small portion of the aqueous liquid vehicle is absorbed into the paper, the increased ionic strength of the monovalent salt in the ink at a surface of the paper causes the pigment to crash at the surface of the paper.

In another example, a method of formulating an ink composition can include dispersing a pigment with a polymer dispersant in an aqueous liquid vehicle, adding a molar concentration of monovalent salt to the liquid vehicle to increase the ionic strength of the monovalent salt, wherein added monovalent salt brings the ionic strength of the ink to within 30% to 95% of a crash point of the pigment. In another example, the monovalent salt can be the ink to from 50% to 90%, or from 60% to 85%, of the molar concentration of the crash point of the pigment. To illustrate by way of example, if the crash point is at about 0.05 M, then the molar concentration of the monovalent salt can added to bring the concentration to from 30% to 95% of 0.05 M (or 50% to 90% 0.05 M; or 60% to 85% 0.05 M). In this example, the steps of dispersing the pigment with the polymer dispersant in the aqueous liquid vehicle and adding the monovalent salt can be carried out in any order or simultaneously.

In another example, a method of determining a crash point of a pigment dispersed by a polymer dispersant can include formulating an ink composition which includes a pigment dispersed by a polymer dispersant, and adding known concentrations of a monovalent salt to the ink composition to formulate multiple test samples. The multiple test samples can be provided by i) incrementally adding known concentrations to the ink composition or ii) adding different known concentrations to multiple portions of the ink composition. Note that the multiple portions can be formulated separately, or can be formulated once and split into smaller aliquots. Additional steps can include measuring colloidal vibrational current of the multiple test samples containing the various known concentrations of the monovalent salt, and determining a peak or near peak colloidal vibrational current which is just prior to a drop in the colloidal vibrational current. The crash point may be found between the peak or near peak colloidal vibrational current and a drop in colloidal vibrational current. In one example, the peak or near peak vibrational current may occur at a monovalent salt concentration from 0.06 M to 0.3 M.

In each of these examples, there are three components that can be used in the present methodology, or which can be formulated together to generate inks with improved saturation or optical density, namely the pigment, the dispersant, and the monovalent salt. The ionic strength of the monovalent salt that provides improved saturation will depend on the pigment and dispersant selected for use. The crash point can be determined experimentally by trial and error, or can be determined using colloidal vibrational current techniques described herein. In any event, the crash point for these three components is not universal, but crash points can be readily determined as described herein, followed by formulating ink compositions, in one example, that include an ionic strength of monovalent salt that approaches the crash point, but does not exceed the crash point, e.g., from 30% to 95% of the crash point.

With specific reference to the pigment, the pigment is not particularly limited. The particular pigment used will depend on the colorists desires in creating the composition. Pigment colorants can include cyan, magenta, yellow, black, red, blue, orange, green, pink, etc. Suitable organic pigments include, for example, azo pigments including diazo pigments and monoazo pigments, polycyclic pigments (e.g., phthalocyanine pigments such as phthalocyanine blues and phthalocyanine greens, perylene pigments, perynone pigments, anthraquinone pigments, quinacridone pigments, dioxazine pigments, thioindigo pigments, isoindolinone pigments, pyranthrone pigments, and quinophthalone pigments), nitropigments, nitroso pigments, anthanthrone pigments such as PR168, and the like. Representative examples of phthalocyanine blues and greens include copper phthalocyanine blue, copper phthalocyanine green and derivatives thereof such as Pigment Blue 15, Pigment Blue 15:3, and Pigment Green 36. Representative examples of quinacridones include Pigment Orange 48, Pigment Orange 49, Pigment Red 122, Pigment Red 192, Pigment Red 202, Pigment Red 206, Pigment Red 209, Pigment Violet 19, and Pigment Violet 42. Representative examples of anthraquinones include Pigment Red 43, Pigment Red 194, Pigment Red 177, Pigment Red 216, and Pigment Red 226. Representative examples of perylenes include Pigment Red 123, Pigment Red 190, Pigment Red 189, and Pigment Red 224. Representative examples of thioindigoids include Pigment Red 86, Pigment Red 87, Pigment Red 198, Pigment Violet 36, and Pigment Violet 38. Representative examples of heterocyclic yellows include Pigment Yellow 1, Pigment Yellow 12, Pigment Yellow 13, Pigment Yellow 14, Pigment Yellow 17, Pigment Yellow 73, Pigment Yellow 90, Pigment Yellow 110, Pigment Yellow 117, Pigment Yellow 120, Pigment Yellow 128, Pigment Yellow 138, Pigment Yellow 150, Pigment Yellow 151, Pigment Yellow 155, and Pigment Yellow 213. Other pigments that can be used include Pigment Blue 15:3, DIC-QA Magenta Pigment, Pigment Red 150, and Pigment Yellow 74. Such pigments are commercially available in powder, press cake, or dispersions form from a number of sources.

If desired, two or more pigments can be combined to create novel color compositions, but the polymer dispersant to pigment weight ratio and the total pigment load may be considered based on the entire pigment load (cumulative based on all pigments). In one example, a pigment combination can form a red ink by combining a magenta pigment and a yellow pigment, e.g. 50-60 wt % magenta pigment and 40-50 wt % yellow pigment. In another example, the pigment combination can form a green ink by combining a yellow pigment and a cyan pigment, e.g., 65-75 wt % yellow pigment and 25-35 wt % cyan pigment. In yet another example, the pigment combination can form a blue ink by combining cyan pigment and magenta pigment, e.g., 85-95 wt % cyan pigment and 5-15 wt % magenta pigment.

The pigments of the present disclosure can be from nanometers to a micron in size, e.g., 20 nm to 1 μm. In one example the pigment can be from about 50 nm to about 500 nm in size. Pigment sizes outside this range can be used if the pigment can remain dispersed and provide adequate printing properties.

The pigment load in the ink compositions can range from 3 wt % to 9 wt %. In one example, the pigment load can be from 3 wt % to 7 wt %, or from 5 wt % to 9 wt %. In a further example, the pigment load can be from 4 wt % to 6 wt %, or from 6 wt % to 8 wt %

With specific reference to the polymer in each of these examples, the polymeric dispersant used can be any suitable polymeric dispersant known in the art that is sufficient to form an attraction with the pigment particles. The dispersant may include acid groups, and/or includes both hydrophilic moieties and hydrophobic moieties. In one example, the dispersant may have an acid number ranging from 40 to 180. The ratio of hydrophilic moieties to the hydrophobic moieties can range widely, but in certain specific examples, the weight ratios can be from about 1:5 to about 5:1. In another example, the ratio of hydrophilic moieties to the hydrophobic moieties can range from about 1:3 to about 3:1. In yet another example, the ratio of hydrophilic moieties to the hydrophobic moieties can range from about 1:2 to about 2:1. In one example, the polymeric dispersant can include a hydrophilic end and a hydrophobic end. The polymer can be a random copolymer or a block copolymer or a graft polymer (comb polymer).

The particular polymeric dispersant can vary based on the pigment; however, as mentioned, the hydrophilic moieties typically include acid groups. Some suitable acid monomers for the polymeric dispersant include acrylic acid, methacrylic acid, carboxylic acid, sulfonic acid, phosphonic acid, and combinations of these monomers. The hydrophobic monomers can be any hydrophobic monomer that is suitable for use, but in one example, the hydrophobic monomer can be styrene. Other suitable hydrophobic monomers can include isocyanate monomers, aliphatic alcohols, aromatic alcohols, diols, polyols, or the like, for example. In one specific example, the polymeric dispersant includes polymerized monomers of styrene and acrylic acid at a 5:1 to 1:5 weight ratio.

The weight average molecular weight (Mw) of the polymeric dispersant can vary to some degree, but in one example, the weight average molecular weight of the polymeric dispersant can range from about 5,000 Mw to about 20,000 Mw. In another example, the weight average molecular weight can range from about 7,000 Mw to about 12,000 Mw. In another example, the weight average molecular weight ranges from about 5,000 Mw to about 15,000 Mw. In yet another example, the weight average molecular weight ranges from about 8,000 Mw to about 10,000 Mw.

In order to formulate the pigment dispersion into an ink composition, the pigment dispersion may be combined with an aqueous liquid vehicle. The liquid vehicle is not particularly limited. The liquid vehicle can include additional polymers, solvents, surfactants, antibacterial agents, UV filters, and/or other additives. However, as part of the ink composition, the pigment is included. In one example, along with other parameters used to determine the crash point and charge stabilization, a lower pigment load may provide for the ability to be more flexible with other parameters, e.g., concentration of dispersant and/or monovalent salt may be lowered with acceptable results.

Turning now to the monovalent salt, any of a number of salts (including monovalent alkali metal salts, monovalent non-metallic salts, or combinations thereof. Examples of monovalent non-metallic salts can include monovalent quaternary ammonium salts [NR⁺⁴], where R is an alkyl group or an aryl group organic salts), e.g., NH₄F, NH₄Cl, NH₄NO₃, (NH₄)₂SO₄, and/or (NH₄)₃PO₄. Examples of monovalent alkali metal salts that can be used include LiF, NaF, KF, RbF, CsF, LiCl, KCl, NaCl, CsCl, RbCl, LiBr, CsBr, RbBr, KBr, NaBr, NH₄Br, Lit, NaI, KI, RbI, CsI, NaNO₃, KNO₃, LiNO₃, RbNO₃, CsNO₃, KNO₃, Li₂SO₄, Na₂SO₄, K₂SO₄, Cs₂SO₄, Rb₂SO₄, Li₃PO₄, Na₃PO₄, K₃PO₄, Rb₃PO₄, Cs₃PO₄, Li₃PO₄, monosodium citrate, disodium citrate, trisodium citrate, potassium citrate, rubidium citrate, cesium citrate, lithium citrate, sodium ascorbate, potassium ascorbate, lithium ascorbate, lithium acetate, sodium acetate, potassium acetate, cesium acetate, rubidium acetate, monosodium glutamate, and/or potassium glutamate. Essentially, any salt that includes a monovalent alkali metal cation or a monovalent non-metallic cation (ionically associated at one or more location to an anion) can be used.

Using only weight percentages to establish the monovalent salt concentration, in some cases, may not provide a detailed or specific enough range or concentration for each and every one of these monovalent salts that may be used. However, to establish generalized ranges, the salt can typically be present in the ink at from 0.25 wt % to 1.2 wt %, 0.3 wt % to 1 wt %, or from 0.3 wt % to 0.8 wt %. These weight ranges are provided primarily for guidance and to emphasize that the range of salt used is typically low, but above at least a minimum threshold of 0.25 wt % to generate improved saturation. When combining specific pigments and specific monovalent salts, ionic strength based on molar concentration can be further used to provide more specific range information where color saturation may be improved further. For example, the molar concentration of the monovalent salt can be from 30% to 95% of the crash point, or from 50% to 90% of the crash point, or from 60% to 85% of the crash point. As mentioned above, the “crash point” can be defined by a molar concentration of the monovalent salt where its ionic strength in the ink is just high enough that electrostatic stabilization provided by the dispersant is not strong enough to prevent the pigment from crashing. In accordance with this, depending on the pigment and monovalent salt selected, the crash point of the pigment may be at a molar concentration of monovalent salt from 0.06 M to 0.3 M, or from 0.1 M to 0.25 M. In other more specific examples, for magenta or yellow pigment, the crash point may be at a molar concentration of monovalent salt of 0.08 M to 0.22 M or from 0.12 M to 0.18 M; and/or for cyan ink, the crash point may be at a molar concentration of monovalent salt of 0.12 M to 0.29 M or from 0.15 M to 0.25 M. Ink compositions with mixtures of pigments used for other colors, e.g., Red, Blue, Green, Purple, Pink, Orange, etc., can be adjusted so that neither pigment reaches its crash point in one example.

One reason crash point is defined based on ionic strength rather than by weight percentage has to do, in part, with the varying molecular weights of the monovalent salts that can be used. That being stated, a weight range from about 0.25 wt % to about 1.2 wt % for the monovalent salt concentration in the ink may be suitably broad enough to cover various pigment and monovalent salt concentrations that are possible. In further detail, some pigments and monovalent salt concentrations may provide crash points that are close to either end of the 0.25 wt % or 1.2 wt % monovalent salt concentration range. To illustrate, monovalent salt concentrations typically below about 0.25 wt % may only provide minimal saturation improvement, even with monovalent salts that are relatively molecularly light, e.g., NaCl, KCl, NaF, KF, etc. Thus, concentrations of 0.25 wt % or more tend to provide more noticeable saturation improvement (but may cause crashing at lower weight percentages). On the other hand, though monovalent salt concentrations above about 1 wt % are typically more than enough to crash most pigments (which is undesirable while in the ink reservoir), for salts having a heavier molecular weight, e.g., CsBr, RbI, Cs₂SO₄, Rb₂SO₄, etc., but which may provide a similar ionic strength as lighter monovalent salts that may alternatively be included at lower weight percentages, monovalent salt concentrations approaching the 1 wt % upper limit may be suitable for use (where a lighter molecular weight monovalent salt with similar ionic properties may cause crashing at a lower weight percentage in the ink composition). For example, a heavy monovalent salt may not provide as much ionic strength per weight percent as a lighter monovalent salt, so a higher weight percentage of the heavier monovalent could be used to formulate an ink having an ionic strength close to the crash point. Likewise, if a heavier monovalent salt is used, 0.1 wt % of the monovalent salt may not provide enough ionic strength to achieve improved color saturation or black optical density, depending in part on the ink formulation density.

In accordance with this, with respect to the monovalent salt, it is noted that weight percentage ranges, e.g., 0.25 wt % to 1.2 wt %, 0.3 wt % to 1 wt %, from 0.3 wt % to 0.8 wt %, etc., and ionic strength ranges, e.g., 0.06 M to 0.3 M, 0.1 M to 0.25 M, 0.08 M to 0.22 M, 0.12 M to 0.18 M, 0.12 M to 0.29 M, 0.15 M to 0.25 M, etc., can be combined together in any combination to provide a monovalent salt concentration profile that is desired for an ink composition to enhance color saturation or optical density. Again, when designing such an ink, the ionic strength of the monovalent salt may also be less than the crash point of the specific pigment/monovalent salt selected for use in the ink composition, e.g., from 30% to 95%, 50% to 90%, 60% to 85%, etc., of the ionic strength of the pigment crash point. Furthermore, pigment concentration ranges, e.g., 3 wt % to 9 wt %, 3 wt % to 7 wt %, 5 wt % to 9 wt %, 4 wt % to 6 wt %, 6 wt % to 8 wt %, etc., and/or pigment to monovalent salt ratio, e.g., 5:1 to 25:1, 9:1 to 20:1, 10:1 to 17:1, etc., can also be combined together with any of the monovalent salt weight percentage ranges and/or the ionic strength ranges (in any combination) to provide an ink profile that improves color saturation or optical density.

Turning now to the aqueous liquid vehicle, solvent of the liquid vehicle can be any solvent or combination of solvents that is compatible with the components of the pigment and polymeric dispersant. As the liquid vehicle is aqueous, water is one of the major solvents (present at more than 10 wt %, and often more than 30 wt % or even more than 50 wt %), and usually, there is one or more organic co-solvent. In some examples, water may be present in an amount representing from about 20 wt % to about 90 wt %, or may be present in an amount representing from about 30 wt % to about 80 wt % of the total ink composition. If an organic co-solvent is added to prepare the pigment dispersion, that co-solvent can be considered when formulating the subsequent ink composition. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, N-methylpyrrolidone (NMP), dimethyl sulfoxide, sulfolane, glycol ethers, alkyldiols such as 1,2-hexanediol, and/or ethoxylated glycerols such as LEG-1, etc. The co-solvent can be present in the ink composition from 5 wt % to about 75 wt % of the total ink composition. In one example, the solvent can be present in the ink composition at about 10 wt % to about 50 wt %, or from about 15 wt % to 35 wt %.

The liquid vehicle can also include surfactants. In general the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, fluorosurfactants and alcohol ethoxylated surfactants can be used as surfactants. In one example, the surfactant can be Tergitol™ TMN-6, which is available from Dow Chemical Corporation. The surfactant or combinations of surfactants, if present, can be included in the ink composition at from about 0.001 wt % to about 10 wt % and, in some examples, can be present at from about 0.001 wt % to about 5 wt % of the ink compositions. In other examples the surfactant or combinations of surfactants can be present at from about 0.01 wt % to about 3 wt % of the ink compositions.

Consistent with the formulations of this disclosure, various other additives may be employed to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide® (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives known to those skilled in the art to modify properties of the ink as desired.

The ink compositions described above are particularly suited to provide good color saturation on non-specialized print media (even uncoated paper) but can be suitable for use on any type of substrate of print media. The reason these inks are particularly useful with plain paper is that color saturation is diminished fairly significantly as colorant and liquid vehicle is soaked into the media substrate. This problem is enhanced when the charge stabilization of the pigment is too high. Pigment formulators tend to stabilize inks with high charges, but as discussed herein, such high charge stabilization may not be the best choice for plain paper when trying to enhance saturation. Adding the right, relatively low, concentration of a monovalent salt as described herein can provide higher saturation as the pigment crashes on the paper when liquid vehicle becomes absorbed into the paper fibers.

Suitable examples of media substrates that can be used include, but are not limited to include, cellulose based paper, fiber based paper, inkjet paper, nonporous media, standard office paper, swellable media, microporous media, photobase media, offset media, coated media, uncoated media, plastics, vinyl, fabrics, and woven substrate. That being described, notably, these inks work surprisingly well on plain paper substrates as described herein.

It is noted that, as used in this specification and the appended claims, the singular forms “a,” “an,” and “the” include plural referents unless the content clearly dictates otherwise.

As used herein “aqueous liquid vehicle” or “liquid vehicle” refers to a water-containing liquid medium in which the pigment, polymeric dispersant, and monovalent salt are admixed in to form an ink composition. In addition to water, the aqueous liquid vehicle can include several components including but not limited to organic co-solvents, surfactants, biocides, UN filters, preservatives, and other additives.

When referring to a “polymer dispersant” herein, this refers to a separate additive that is included with the pigment to disperse the pigment. The polymer dispersant can be adsorbed or attracted to the surface of the pigment, but is not covalently attached as is the case with self-dispersed pigments.

Color “saturation” refers to the intensity of color, expressed by the degree from which it differs from white. It can be expressed as C/L*. Notably, saturation relates to color. However, in accordance with examples of the present disclosure, when a black pigment is used, optical density (OD) rather than color saturation can be used to describe the increased intensity. Thus, examples and discussion herein related to color saturation may also be relevant to optical density with respect to black pigment. Thus, any disclosure related to color saturation should be read to include black optical density (for black inks), whether explicitly stated so in a specific context or not.

Converting molar concentration to weight percent includes taking into account the molecular weight of the monovalent salt and the density of the liquid ink. Typically, the density of the ink can be from about 1.04 g/cm³ to about 1.12 g/cm³, or from about 1.06 g/cm³ to about 1.1 g/cm³, or so, depending on the ink formulation.

Notably, there may be some added ingredients that may include some incidental concentrations of monovalent salt that are inherently in the formulation of the additive. This monovalent salt is not calculated when determining the molar concentration of the added monovalent salt unless the salt that is already present in an additive is identical to the salt being added to increase the ionic strength.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

When referring to an increase or improvement in performance, the increase or improvement is based on printing using Hammermill® Great White 30% Recycled Media as the print medium which was available at the time of filing of the disclosure in the United States Patent and Trademark Office.

### Examples

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the spirit and scope of the present disclosure. The appended claims are intended to cover such modifications and arrangements. Thus, while the technology has been described above with particularity, the following provide further detail in connection with what are presently deemed to be certain acceptable examples.

### Example 1—Preparation of Ink Compositions with Pigment Dispersions and Monovalent Salt

Three pigment dispersions formulated with Cyan, Magenta, and Yellow pigments, respectively, and dispersed with a separate polymer dispersant were formulated into inkjet ink compositions. These inkjet ink compositions were further modified with the addition of different concentrations of monovalent salt, namely potassium chloride salt. Specifically, multiple samples of each ink color was prepared with incrementally increasing concentrations of KCl, ranging from 0 wt % to about 2 wt % (0 to about 0.29 M). Thus, several ink samples were prepared from three colors and using multiple salt concentrations. With the varying concentrations of KCl, the pigment and solvent concentrations were held constant. The formulation for each of the inks is shown below in Table 1, as follows:

TABLE 1
Ink Compositions With Incrementally Increased Salt Concentration

| Ingredient | Class | Weight % |
|---|---|---|
| 2-Pyrrolidinone | Solvent | 9 |
| EHPD | Solvent | 10 |
| Glycerol | Solvent | 4 |
| LEG-1 | Solvent | 0.75 |
| Tergitol ® TMN6 | Surfactant | 0.6 |
| Acticide ® B20 | Biocide | 0.16 |
| Acticide ® M20 | Biocide | 0.07 |
| Potassium Chloride | Salt | 0 to 2 |
| Color Pigment Dispersion | Pigment | 6 |
| Water | | Balance |

Tergitol ® is available from Sigma Aldrich; and Acticide ® is available from Thor Group Limited.

### Example 2—Colloidal Vibrational Current

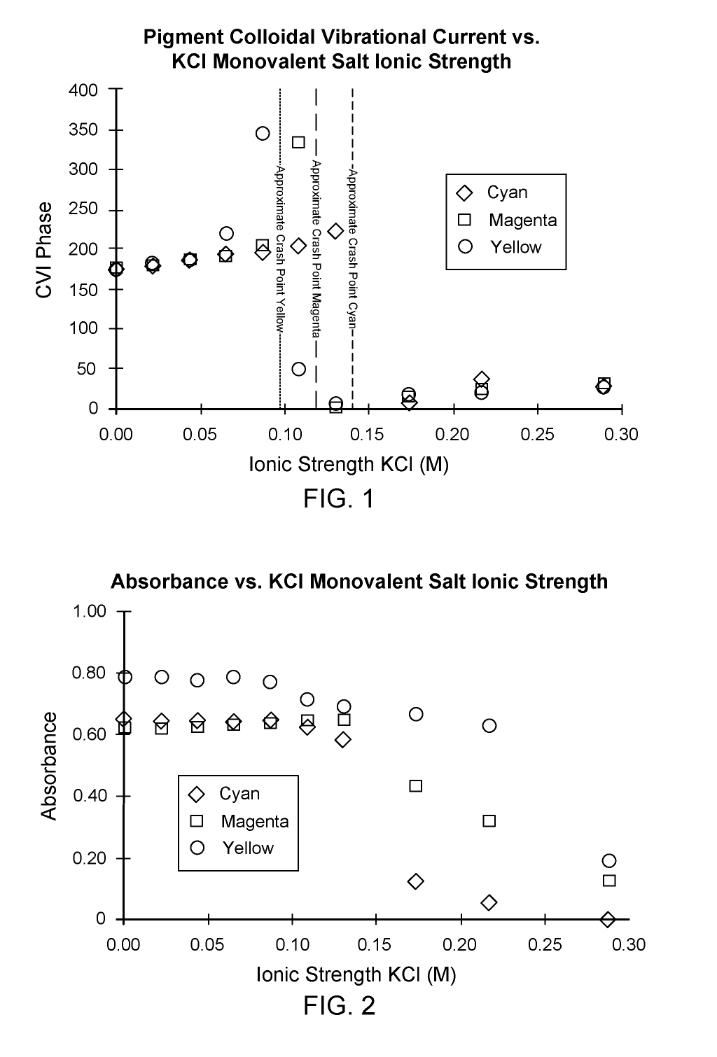

Each of the inks prepared in accordance with Example 1 was evaluated for pigment colloidal vibrational current (CVI) using a model DT-100 acoustic spectrometer from Dispersions Technology Inc. For each KCl concentration, the CVI phase measurement was averaged over several acquisitions. The results are shown in FIG. 1. As can be seen, crash points were identified based on the location on the chart where the CVI phase (theta, 8) dropped significantly from at least above about 200 for cyan and at least above 300 for magenta and yellow to below 50 for all three ink colors.

### Example 3—Absorbance

The inks prepared in accordance with Example 1 were diluted in accordance with an acceptable UV absorbance range (following Beer's Law), which was about a 1 to 5000 dilution by volume. The Absorbance values are shown in FIG. 2. This UV-Vis experiment provides complimentary confirmation of the CVI data provided in Example 2. In this example, the saturation remains essentially constant and drops is because as the salt is controlled, the visual color spectrum remains constant until the crash point is reached. Once that occurs, the particles crash and color absorbance consequently goes down. In some instances, good saturation extends beyond the crash (but would not be suitable for inkjetting due to the crash) because the polymer dispersant that stabilizes the pigments also has non-ionic components that are not affected by monovalent salt. Additionally, binding interactions can be very different for each pigment and therefore, the non-ionic component that binds strongest to the pigment, in this instance cyan, may be shielded the most from the monovalent salt and crash out the slowest.

### Example 4—Saturation

Several ink compositions were prepared in accordance with Example 1 and saturation values for primary color inks (Cyan, Magenta, and Yellow), as well as secondary color ink mixtures (Red, Green, and Blue), were measured. Specifically, each primary and secondary color was prepared at five KCl, as set forth in Table 2 below. The range of 0 to 1 wt % KCL was chosen because all of the colored pigments, as confirmed by Example 2, had crashed before reaching a 1 wt % (about 0.14 M) concentration of KCl (with cyan crashing last). Saturation (C/L*) data for each of the inks with different potassium chloride concentrations was measured. This data demonstrates how salt addition in relatively small concentrations can improve color saturation.

TABLE 2
Color Saturation on Hammermill Great
White 30% Recycled Office Paper

| | Saturation at 60 ng/300^{th} | | | | | |
|---|---|---|---|---|---|---|
| Wt % Salt | Cyan | Magenta | Yellow | Red | Green | Blue |
| 0% | 0.88 | 1.07 | 0.94 | 0.93 | 0.84 | 0.85 |
| 0.25% | 0.95 | 1.18 | 1.00 | 1.11 | 0.95 | 0.95 |
| 0.50% | 0.97 | 1.27 | 1.02 | 1.18 | 0.98 | 0.98 |
| 0.75% | 1.04 | 1.33 | 1.04 | 1.21 | 1.07 | 1.06 |
| 1.00% | 1.03 | 1.37 | 1.03 | 1.27 | 1.00 | 1.05 |

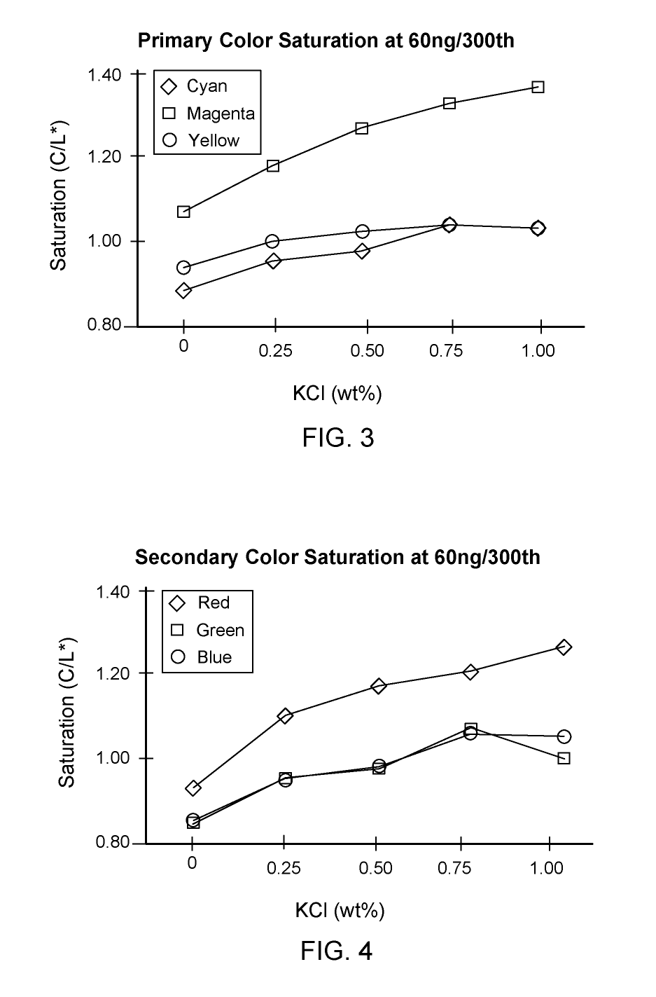

The date shown in Table 2 above is provided in FIG. 3 (primary colors) and FIG. 4 (secondary mixture colors). As can be seen, the trend of saturation increases as the salt concentration increases. At some concentration of monovalent salt, e.g., below 1 wt % in these examples but may be up to 1.2 wt % in other examples, the crash point may be reached and the pigment will not remain stable in the ink, which can cause nozzle clogging and other printing issues. Thus, even though the pigment crashes in all of these inks before about 1 wt % KCl, saturation may continue to increase or drop somewhat, but for the most part, may level off (note that magenta and yellow level off at about their respective crash points and there is not enough data to show how cyan saturation changes after crash). Regardless of the saturation curve, above the crash point, inks are not typically in an appropriate condition for jetting. Thus, by maximizing color saturation (or optical density for black) and adding monovalent salt at a concentration that is lower than the pigment crash point, highly saturated inks for inkjet printing can be formulated.

While the present technology has been described with reference to certain examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. An ink composition, comprising:
an aqueous liquid vehicle;
from 3 wt % to 9 wt % pigment dispersed in the aqueous liquid vehicle by a polymer dispersant associated with pigment; and
from 0.25 wt % to 1.2 wt % monovalent salt,
wherein the pigment to monovalent salt weight ratio in the ink composition is from 5:1 to 25:1.

2. The ink composition of claim 1, wherein the monovalent salt includes an alkali metal salt.

3. The ink composition of claim 1, wherein the monovalent salt includes a monovalent non-metallic salt.

4. The ink composition of claim 1, wherein the pigment is present at from 5 wt % to 9 wt %, and wherein the monovalent salt concentration is from 0.3 wt % to 0.8 wt %.

5. The ink composition of claim 1, wherein the pigment has a crash point at a molar concentration of the monovalent salt in the ink composition, and wherein the monovalent salt is present at from 30% to 95% the molar concentration.

6. The ink composition of claim 5, wherein the monovalent salt is present at a molar concentration from 50% to 90% of the crash point.

7. The ink composition of claim 5, wherein the crash point is from 0.06 M to 0.3 M.

8. The ink composition of claim 5, wherein the pigment is magenta or yellow, and the crash point is from 0.08 M to 0.22 M.

9. The ink composition of claim 5, wherein the pigment is cyan, and the crash point is from 0.12 M to 0.29 M.

10. The ink composition of claim 1, wherein the pigment remains stable while in an inkjet fluid container, and wherein when the ink composition is printed on plain paper, aqueous liquid vehicle is absorbed into the paper thus increasing the ionic strength of the monovalent salt at a surface of the paper causing the pigment to crash at the surface of the paper.

11. A method of formulating an ink composition, comprising:
dispersing a pigment with a polymer dispersant in an aqueous liquid vehicle; and
adding a monovalent salt to the aqueous liquid vehicle, wherein the monovalent salt brings the ink to from 30% to 95% of a molar concentration of a crash point of the pigment.

12. The method of claim 11, wherein the crash point of the pigment is from 0.06 M to 0.3 M.

13. The method of claim 11, wherein the monovalent salt brings the ink to from 50% to 90% of the molar concentration of the crash point of the pigment.

14. A method of determining a crash point of a pigment dispersed by a polymer dispersant, comprising:
formulating an ink composition which includes a pigment dispersed by a polymer dispersant;
adding known concentrations of a monovalent salt to the ink composition to formulate multiple test samples, the multiple test samples provided by i) incrementally adding known concentrations to the ink composition or ii) adding different known concentrations to multiple portions of the ink composition;
measuring colloidal vibrational current of the multiple test samples containing the various known concentrations of the monovalent salt; and
determining a peak or near peak colloidal vibrational current which is just prior to a drop in the colloidal vibrational current, wherein the crash point is between the peak or near peak colloidal vibrational current and a drop in colloidal vibrational current.

15. The method of claim 14, wherein the crash point occurs at a monovalent salt concentration at from 0.06 M to 0.3 M.
